(19) United States
(12) Patent Application Publication
(10) Pub. No.: US 2022/0036372 A1
(43) Pub. Date: Feb. 3, 2022

(54) Method, device and storage medium for masterplan's compliance checking based on standards and codes of urban planning and building design

(71) Applicant: Shenzhen XKool Technology CO., Ltd, Shenzhen (CN)

(72) Inventors: Xiaodi Yang, Shenzhen (CN); Weilong Liao, Shenzhen (CN)

(21) Appl. No.: 17/450,988

(22) Filed: Oct. 14, 2021

(30) Foreign Application Priority Data
Mar. 20, 2020 (CN) 202010170344.2

(51) Int. Cl. G06Q 30/00; G06Q 50/08

(52) U.S. Cl. CPC G06Q 30/018; G06Q 50/08

(57) ABSTRACT

The present disclosure discloses a method, device and storage medium based on standards and codes of urban planning and building design for masterplan's compliance checking.

The method comprises: by getting the design information of the building group, and acquiring the urban planning and design standards and codes corresponding to the building group according to the city where the building group is located, each building corresponding to the design information of the building group is described as a geometry, determining the shortest distance between two adjacent geometries based on the corresponding geometry of each building, judging whether the shortest distance of the corresponding building complies with the building spacing standards and codes of the corresponding city's urban planning, prompt for not complying with the corresponding building spacing standards and codes, so that the user can make modification to the building group design based on the prompt.

### TECHNICAL FIELD

The present disclosure relates to the technical field of architectural design, and in particular to a method, device and storage medium for masterplan's compliance checking based on standards and codes of urban planning and building design.

### BACKGROUND

With the continuous advancement of digitalization and information technology, the existing architectural design, designers usually use computer-aided design CAD to draft and plan the design of the building, followed by the examination of design models and drawings, and then provide them to the construction unit for construction work. If the building designed by the design model and drawings does not meet the standards and codes of urban planning and building design, the design needs to be reworked, which affects the construction schedule of the project. Due to the lack of technology at this stage, most of the projects are artificially checked by experts after design, that is, the designed drawings are compared with the design codes of the construction industry, which will produce problems such as high mis-checking rate, low inspection strength and huge cost for modification. Therefore, the design of the building needs to be checked for compliance to standards and codes of urban planning and building design with the help of a masterplan's compliance checking tool.

In the existing masterplan's compliance checking tools, the outline and size of construction area, housing unit area and room area are generally identified by reading the CAD design of the building to determine whether the building complies with the construction area standards and codes. However, among the standards and codes of urban planning and building design, there are not only construction area standards and codes, but also other construction standards and codes. These masterplan's compliance checking tools are only able to check compliance with standards and codes of urban planning and building design related to construction area by the outline and size of buildings in the design plan, cannot determine whether the distances between buildings comply with the spacing of multiple buildings away from the standards and codes of urban planning and building design, and cannot check the building design plan in order to make the designed buildings meet the standards and codes of urban planning and building design.

### SUMMARY

The present disclosure provides a method, device and storage medium for masterplan's compliance checking based on standards and codes of urban planning and building design to solve the problem of non-compliance with standards and codes of urban planning and building design that easily occurs in masterplan's compliance checking in the existing technology.

A method for masterplan's compliance checking based on standards and codes of urban planning and building design, comprises:

acquiring the design information of the building group, and acquire the standards and codes of urban planning and building design corresponding to the building group according to the city where the building group is located. Design information for the building groups comprises the cities in which the building groups are located;

describing each building corresponding to the design information of the building group as a geometry;

determine the shortest distance between the two adjacent geometries based on the corresponding geometry of each building;

Judging, on the basis of the shortest distance, whether the spacing of the corresponding buildings complies with the building spacing standards and codes of urban planning and design;

if the distance between corresponding buildings does not comply with the corresponding building spacing standards and codes, prompt for not complying with the corresponding building spacing standards and codes, so that the user can make changes to the building group design information based on the prompt.

Further, the acquiring the standards and codes of urban planning and building design corresponding to the building groups according to the city in which the building groups is located, comprising:

acquiring preset data of standards and codes of urban planning and building design, the preset data of standards and codes of urban planning and building design is generated with statistics on standards and codes of urban planning and building design for each city region in the country;

search and acquire the standards and codes of urban planning and building design of the building group according to the preset data of standards and codes of urban planning and building design of the city where the building group is located in.

Further, the method for generating the preset data of standards and codes of urban planning and building design, comprises:

acquiring documents related to standards and codes of urban planning and building design in various urban areas of the country, and summarizing them into a document pool;

screening each of the documents in the document pool to extract text and diagrams describing specific standards and codes of urban planning and building design to acquire the preset data of standards and codes.

Further, the prompt of non-compliance with the corresponding building spacing standards and codes, comprising:

marking of the corresponding buildings that do not meet the corresponding building spacing standards and codes;

prompting the user for not complying with the corresponding building spacing standards and codes.

Further, the corresponding building spacing standards and codes, comprises: gable wall spacing standards and codes, fire protection spacing standards and codes and obstructive buildings standards and codes.

Further, the design information of building groups, and comprising the corresponding construction area of each building, as, after acquiring the standards and codes of urban planning and building design corresponding to the building groups according to the city in which the building groups are located, comprising:

judging whether the construction area of each of the buildings complies with the construction area standards and codes of the corresponding standards and codes of urban planning and building design;

if the construction area of each of the buildings does not comply with the corresponding construction area standards and codes, a notification is made to the corresponding construction area standards and codes that do not comply with so that the user can make changes to the building group design information in accordance with the notification.

A device for masterplan's compliance checking based on standards and codes of urban planning and building design, comprising:

an acquiring module, for acquiring design information for building groups, acquiring the standards and codes of urban planning and building design corresponding to the building groups according to the cities in which the building groups are located, the building group design information comprising the cities in which the building groups are located;

a describing module, for describing each building corresponding to the design information of building group as a geometry;

a determining module, for determining the shortest distance between two adjacent geometries according to the geometry corresponding to each building;

a Judging module, for judging on the basis of the shortest distance, whether the distance between corresponding buildings complies to the building spacing standards and codes of the corresponding standards and codes of urban planning and building design;

a prompting module, for prompting the non-complying with corresponding building spacing standards and codes if the distance of the corresponding buildings does not comply with the corresponding building spacing standards and codes, so that the user can make changes to the building group design information according to the prompt.

Further, the acquiring module is specifically configured to:

acquire the data of preset city's standards and codes of urban planning and building design;

search and acquire the standards and codes of urban planning and building design of the building group according to the preset data of standards and codes of urban planning and building design of the city where the building group is located in.

A device for masterplan's compliance checking based on standards and codes of urban planning and building design, comprising a memory, a processor, and a computer program stored in the memory and operable on the processor, the processor performs computer program to implement the steps of the method for masterplan's compliance checking based on standards and codes of urban planning and building design as described above.

A readable storage medium, the readable storage medium storing a computer program, the processor performs the computer program to implement the steps of the method for masterplan's compliance checking based on standards and codes of urban planning and building design as described above.

The proposed scheme of the method, device and storage medium for checking plans based on standards and codes of urban planning and building design as described above, by acquiring the design information of the building group, and acquiring the standards and codes of urban planning and building design corresponding to the building group according to the city where the building group is located, each building corresponding to the design information of the building group is described as a geometry. Determining the shortest distance between two adjacent geometries based on the corresponding geometry of each building, judging whether the shortest distance of the corresponding building complies with the building spacing standards and codes of the corresponding city's urban planning and design, prompting the non-complying with corresponding the building spacing standards and codes if the distance of the corresponding buildings does not comply with the corresponding building spacing standards and codes, so that the user can make changes to building group design information according to the prompt. The present disclosure, by describing each building as a geometry, determines whether the shortest distance between two adjacent geometries complies with the corresponding building spacing standards and codes based on the corresponding geometry of each building, quickly check building group design information for urban planning and design spacing standards and codes, enabling users to quickly check their building group design information for buildings that do not pass the check according local building spacing standards and codes, and makes it convenient for users to quickly check and modify the design plan according to the checking results in order to make the designed masterplan meet the construction standards and codes, improving the masterplan's compliance checking effort and efficiency.

### BRIEF DESCRIPTION OF DRAWINGS

In order to describe the technical solutions of the embodiments of the present disclosure, below is simple introduction to the figures used in the embodiment describing of the present disclosure. Apparently, the figures described below are only some embodiments of the present disclosure, for those of ordinary skill in the art, other figures can also be obtained based on these figures without contribution of creative work.

FIG. 1 is a schematic diagram of an application environment for masterplan's compliance checking method based on the standards and codes of urban planning and building design in one embodiment of the present disclosure;

FIG. 2 is a processing schematic flow chart of the masterplan's compliance checking method based on the standards and codes of urban planning and building design in one embodiment of the present disclosure;

FIG. 3 is a processing schematic diagram of step S10 of the masterplan's compliance checking method based on the standards and codes of urban planning and building design in one embodiment of the present disclosure;

FIG. 4 is a structural schematic diagram of the masterplan's compliance checking device based on the standards and codes of urban planning and building design in one embodiment of the present disclosure;

FIG. 5 is another structure schematic diagram of an application environment for a masterplan's compliance checking device based on the standards and codes of urban planning and building design in one embodiment of the present disclosure.

### DESCRIBING OF EMBODIMENTS

Below is clear and complete describing of the technical solutions in the embodiments of the present disclosure in conjunction with the figures of such embodiments, apparently, the embodiments described are some embodiments of the present disclosure only rather than all embodiments. Any other embodiment obtained by the embodiments of the present disclosure is within the protective scope of the present disclosure.

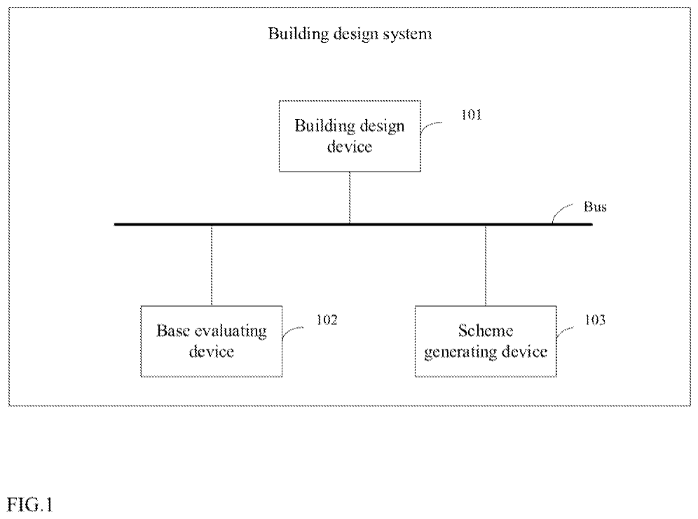

The embodiment of the present disclosure provides the method for masterplan's compliance checking based on standards and codes of urban planning and building design which can be applied in an application environment as shown in FIG. 1. The masterplan's compliance checking system based on standards and codes of urban planning and building design comprises a client and the device for masterplan's compliance checking based on standards and codes of urban planning and building design as shown in FIG. 1. Specifically, the method for masterplan's compliance checking based on standards and codes of urban planning and building design is applied to the device for masterplan's compliance checking based on standards and codes of urban planning and building design of a masterplan's compliance checking system based on standards and codes of urban planning and building design, among them, the client communicates with the device for masterplan's compliance checking based on standards and codes of urban planning and building design through a network for data transfer. Among them, the client, also known as the user terminal, is the program that corresponds to the server and provides local services to the client. The client can be installed on, but not limited to, a variety of personal computers, laptops, smartphones, tablets and portable wearable devices.

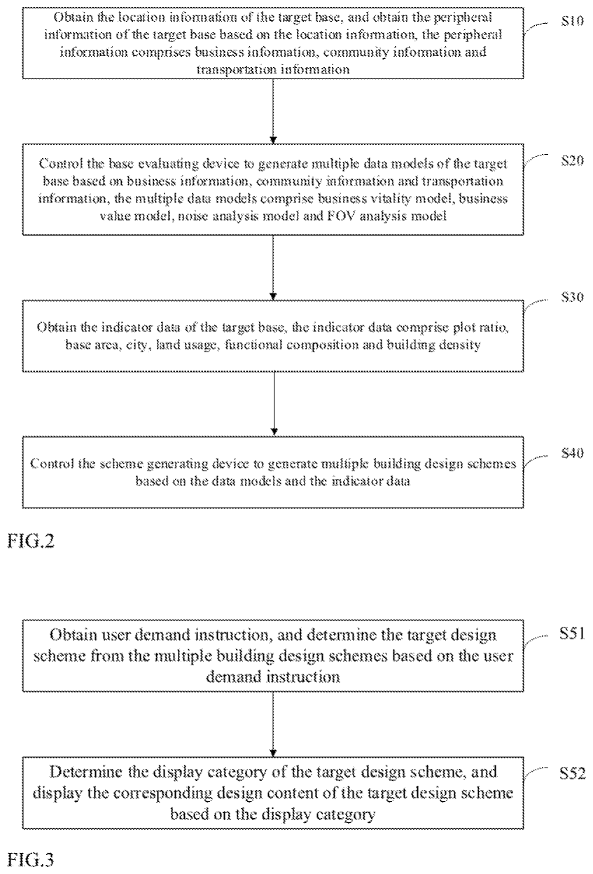

In one embodiment, as shown in FIG. 2, provide a method for masterplan's compliance checking based on standards and codes of urban planning and building design, take the method applied in the device for masterplan's compliance checking based on standards and codes of urban planning and building design in FIG. 1 as an example for describing, which comprise the following steps.

S10: acquire the design information of the building group, and acquire the urban planning and design standards and codes corresponding to the building group according to the city where the building group is located. Design information for the building group comprises the city in which the building group is located.

Receive the building group design information sent by the user through the client, the building group design information comprises the city where the building group is located, and after acquiring the building group design information, acquire the standards and codes of urban planning and building design corresponding to the building group according to the city where the building group is located.

For example, after acquiring the design information of a building group, if the city where the building group is located is Tianjin, the standards and codes of urban planning and building design of Tianjin will be acquired.

S20: describe each building corresponding to the design information of the building group as a geometry.

After acquiring the building group design information, all the corresponding buildings in the building group design information are described as geometry, and the relationship between buildings is realized as a relative spatial relationship between geometries.

S30: determine the shortest distance between two adjacent geometries based on the corresponding geometry of each building.

Determine the shortest distance between two adjacent geometries based on the corresponding geometry of each building.

Among them, the shortest distance between two adjacent geometries can be determined based on the counterclockwise angle between the axes of the two building geometries intersecting in the due south direction and the building height.

S40: judge on the basis of the shortest distance, whether the spacing of the corresponding buildings complies with building spacing standards and codes of urban planning and design.

Realizing the checking of standard and code between buildings as the judging of relative spatial relationship between geometries, and after acquiring the shortest distance between two adjacent geometries, the shortest distance is converted into the actual shortest distance between two buildings corresponding to the two geometries according to the scaling ratio, and then the actual shortest distance between two buildings is judged to be in compliance with the building spacing standard and code corresponding to the standards and codes of urban planning and building design. For example, whether the actual shortest spacing between two buildings is larger than the shortest building spacing in the city where the building is located.

Among them, based on the counterclockwise angle of the axis of the two adjacent buildings intersecting with due south direction, the height of the building and the type of the building, judge whether the actual shortest distance between the two adjacent buildings meets the corresponding building spacing standards and codes.

For example, building types comprise low-rise buildings, high-rise buildings and super high-rise buildings, and the building standards and codes for each building type have different building spacing regulations, so it is important to judge whether the building spacing meets the building spacing standards and codes according to the actual building type.

In another embodiment, the corresponding building spacing standards and codes, comprising: gable wall spacing standards and codes, fire protection spacing standards and codes and obstructive buildings standards and codes.

S50: if the distance between corresponding buildings does not comply with the corresponding building spacing standards and codes, prompt for not complying to the corresponding building spacing standards and codes, so that the user can make changes to the building group design information based on the prompt.

After acquiring the shortest distance of each adjacent two geometries in the building group and converting the shortest distance to the actual shortest spacing of the corresponding two adjacent buildings, If the distance between two adjacent buildings does not comply with the corresponding building spacing standards and codes, the user will be prompted with the corresponding building spacing standards and codes that do not comply with, so that the user can modify the building group design information according to the prompt.

In this embodiment, the proposed scheme of a method, device and storage medium for masterplan's compliance checking based on standards and codes of urban planning and building design as above, by acquiring the design information of the building group, and acquiring the standards and codes of urban planning and building design corresponding to the building group according to the city where the building group is located, each building corresponding to the design information of the building group is described as a geometry. Determining the shortest distance between two adjacent geometries based on the corresponding geometry of each building, judging whether the shortest distance of the corresponding building complies with the building spacing standards and codes of the corresponding city's urban planning and design, prompting the non-complying with corresponding the building spacing standards and codes if the distance of the corresponding buildings does not comply with the corresponding building spacing standards and codes, so that the user can make changes to building group design information according to the prompt. The present disclosure, by describing each building as a geometry, determines whether the shortest distance between two adjacent geometries complies with the corresponding building spacing standards and codes based on the corresponding geometry of each building, quickly check building group design information for urban planning and design spacing standards and codes, enabling users to quickly check their building group design information for buildings that do not pass the masterplan's compliance checking according local building spacing standards and codes, and makes it convenient for users to quickly check and modify the design plan according to the checking results in order to make the designed masterplan meet the construction standards and codes, improving the masterplan's compliance checking effort and efficiency.

In one embodiment, if the spacing of the corresponding building does not comply with the corresponding building spacing standard and code, in the step S50, i.e., the non-complying with corresponding building spacing standards and codes are indicated, which specifically comprises the following steps.

S510: mark of the corresponding buildings that do not meet the corresponding building spacing standards and codes.

After acquiring the shortest distance of each adjacent two geometries in the building group and converting the shortest distance to the actual shortest distance of the corresponding two adjacent buildings, If the distance between two adjacent buildings does not comply with the corresponding building spacing standards and codes, the user will be prompted with the corresponding building spacing standards and codes that do not comply with.

For example, if the building group is in Tianjin and the actual shortest distance between building A and adjacent building B in the building group is x meters, which does not satisfy the building spacing standards and codes specified in article n of the building spacing standards and codes of Tianjin's urban building code, the user is prompted that building A and building B do not satisfy the building spacing code, and the geometry corresponding to building A and building B is highlighted.

Furthermore, the shortest distance between the geometry of the non-complying with building A and the geometry of the adjacent building B can also be shown on the line connecting the two geometries.

S520: the corresponding building spacing standards and codes that are not complying with will be prompted to the user.

After acquiring the shortest distance of each adjacent two geometries in the building group and converting the shortest distance to the actual shortest distance of the corresponding two adjacent buildings, If the distance between two adjacent buildings does not comply with the corresponding building spacing standards and codes, the user will be prompted with the corresponding building spacing standards and codes that does not comply with.

For example, if the building group is in Tianjin and the actual shortest distance between building A and adjacent building B in the building group is x meters, which does not satisfy the building spacing standards and codes specified in article n of the building spacing standards and codes of Tianjin's urban building code, the user is prompted that building A and building B do not satisfy the building spacing code specified in article n of the building spacing code of Tianjin's urban building code, and the specified in article n is shown.

In this embodiment, if the distance of the corresponding building does not comply with the corresponding building spacing standards and codes, by marking the corresponding building that does not comply with the corresponding building spacing standards and codes, and prompting the user of the corresponding building spacing that does not comply to the corresponding building spacing standards and codes, enables users to quickly identify buildings that do not pass local building spacing standards and codes in their building design plans and the specific code content, make it easier for the relevant personnel to modify the buildings that do not meet the requirements according to the checking results and the specific content of the standards and codes, improving the checking efficiency.

In one embodiment, after acquiring the design information of the building groups comprising the cities where the building groups are located, as shown in FIG. 3, in the step S10, i.e., acquiring the standards and codes of urban planning and building design corresponding to the building groups according to the cities where the building groups are located, specifically comprise the following steps:

S11: acquiring the preset data of standards and codes of urban planning and building design, predetermine data of standards and codes of urban planning and building design being generated with statistics on standards and codes of urban planning and building design for each city region in the country.

After acquiring the design information of the building groups in the cities where the building groups are comprised, acquire the preset data of standards and codes of urban planning and building design, the preset data of standards and codes of urban planning and building design be generated with statistics on standards and codes of urban planning and building design for each city region in the country.

Among them, the method of generating preset data of standards and codes of urban planning and building design, comprising:

S111: acquire documents related to standards and codes of urban planning and building design in each urban area of the country and summarize them into a pool of documents.

Receive documents related to standards and codes of urban planning and building design in all urban areas of the country sent by users through the client, and summarize all documents into a pool of documents, among them, documents related to standards and codes of urban planning and building design in urban areas across the country comprise documents such as standards and codes of urban planning and building design or guidelines obtained from the government, architectural design institutes or real estate developers in various provinces and cities.

S112: screening of each document in the document pool to extract text and diagrams describing specific standards and codes of urban planning and building design to acquire the predefined data of standards and codes.

For each document in the document pool, the text is first screened to remove the describing text that is not related to the specific construction standards and codes, the text and schematic diagrams describing the building codes are extracted, the extracted text and schematic diagrams describing the construction standards and codes are summarized into the corresponding standards and codes of urban planning and building design for each city according to their corresponding cities to obtain the preset data of standards and codes, which comprise the building spacing standards and codes.

Among them, it is also possible to classify the preset numerical parameters of codes into a table, so that users can quickly extract the corresponding data of construction standards and codes according to the preset data of codes.

In this embodiment, by acquiring documents related to standards and codes of urban planning and building design in each urban area of the country, summarizing them into a document pool, and screening each document in the document pool to extract text and diagrams describing specific standards and codes of urban planning and building design to acquire preset data of standards and codes, the preset data of codes can support different versions of standards and codes of urban planning and building design in all urban areas of the country, which provides a sufficient data base for the subsequent code compliance check of buildings according to the corresponding standards and codes of urban planning and building design, improves the reliability of codes compliance checking for the data of building group design and enhances masterplan's compliance checking effort and efficiency.

S12: according to the city where the building group is located, find and acquire the corresponding standards and codes of urban planning and building design of the building group in the preset data of standards and codes of urban planning and building design.

Acquire the generated preset data of standards and codes of urban planning and building design, search and acquire the standards and codes of urban planning and building design corresponding to the building group based on the city where the building group is located, acquiring the preset data of standards and codes of urban planning and building design.

In this embodiment, acquire the preset data of standards and codes of urban planning and building design, search and acquire the standards and codes of urban planning and building design of the building group according to the city where the building group is located in the preset data of standards and codes of urban planning and building design, provides a sufficient database for the subsequent code compliance check of buildings according to the corresponding standards and codes of urban planning and building design, improves the accuracy of standards and codes compliance checking for the data of building group design and enhances masterplan's compliance checking effort and efficiency.

In one embodiment, the design information of building groups, comprising the corresponding construction area of each building, after process S10, i.e., acquiring the standards and codes of urban planning and building design corresponding to the building groups according to the cities where the building groups are located, the method specifically comprise the following steps:

S21: judging whether the construction area of each of the buildings complies to the construction area standards and codes of corresponding standards and codes of urban planning and building design.

After acquiring the design information of a building group comprising the construction area of each of building, and acquiring the standards and codes of urban planning and building design corresponding to the building group according to the city where the building group is located, judge whether the construction area of each of building complies with the construction area standards and codes of the corresponding standards and codes of urban planning and building design based on the construction area of each building.

Among them, the construction area comprises the area of the building itself area, the housing unit area and the room area.

In the process of judging whether the construction area of each building complies with the construction area standards and codes of the corresponding standards and codes of urban planning and building design, judge whether the area of the building itself, the housing unit area and the room area comply with the corresponding construction area standards and codes, respectively.

S22: if the construction area of each building does not comply to the corresponding construction area standards and codes, a prompt is made to the corresponding construction area standards and codes that do not comply with so that the user can make changes to building group design information in accordance with the prompt.

After judging whether the area of the construction area, the housing unit area and the room area comply with the corresponding construction area standards and codes respectively, if the construction area of each building does not comply with the corresponding construction area standards and codes, a notification is made to the corresponding construction area standards and codes that do not comply with so that the user can make changes to building group design information in accordance with the notification.

Among them, reminding the corresponding construction area standards and codes for non-complying, comprising:

S221: Marking of the corresponding buildings that do not meet the corresponding building spacing standards and codes.

After judging whether the construction area, the housing unit area and the room area comply with the corresponding construction area standards and codes respectively, if the construction area of each building does not comply with the corresponding construction area standards and codes, a notification is made to the corresponding construction area that do not comply with so that the user can make changes to building group design information of corresponding construction area in accordance with the notification.

For example, the construction area and housing unit area of building C, are in compliance with the corresponding construction area standards and codes, but the room area does not comply with the article of the construction area standards and codes, the construction area standards and codes will be marked with a highlight to prompt the user to make changes to the room area of building C.

S222: The corresponding building spacing standards and codes that are not complying will be prompted to the user.

After judging whether the area of the construction area, the housing unit area and the room area comply with the corresponding construction area standards and codes respectively, if the construction area of each building does not comply with the corresponding construction area standards and codes, a notification is made to the corresponding construction area that do not comply with so that the user can make changes to building group design information of corresponding construction area.

For example, the area and housing unit area of building C, are in compliance with the corresponding construction area standards and codes, but the room area does not comply with article m of the construction area standards and codes, the construction area standards and codes will be displayed to prompt the user to make changes to the room area of building C.

In this embodiment, by judging whether the construction area of each building complies with the corresponding construction area standards and codes of the standards and codes of urban planning and building design, if the construction areas of each building does not comply with the corresponding construction area standards and codes, the corresponding construction area standards and codes that do not comply with are reminded so that the user can make changes to the building group design information based on the reminder, enable users to quickly identify buildings that do not pass local construction area codes in their building design plans and the specific code content, make it easier for the relevant personnel to modify the buildings that do not meet the requirements according to the checking results and the specific content of the standards and codes, improving the masterplan's compliance checking efficiency.

It shall be understood that the sequence numbers of the steps in the embodiments described above don't indicate the order of execution seniority, and the order of executing the processes shall be determined by the functionality and internal logic without constituting any limitation to the implementation process of the embodiments in the present disclosure.

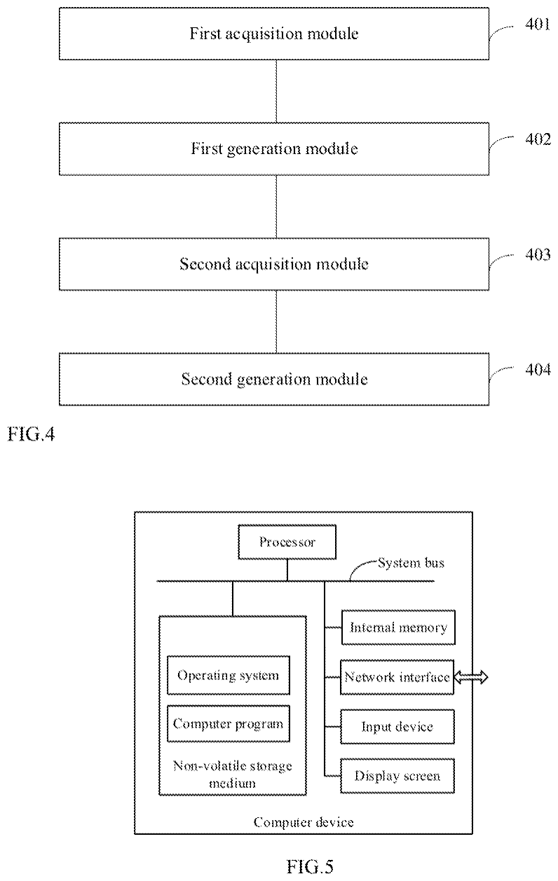

In one embodiment, provide a device for masterplan's compliance checking based on standards and codes of urban planning and building design, this device for masterplan's compliance checking based on standards and codes of urban planning and building design corresponds to the method for masterplan's compliance checking based on standards and codes of urban planning and building design in the above embodiment. As shown in FIG. 4, the device for masterplan's compliance checking based on standards and codes of urban planning and building design comprises an acquiring module 401, a describing module 402, a determining module 403, a judging module 404, and a prompting module 405. Detailed describing of the functional modules is as follow:

acquiring module 401, acquiring design information for building groups, acquiring the standards and codes of urban planning and building design corresponding to the sated building groups according to the cities where the building groups are located, design information for the building groups comprising the cities in which the building groups are located;

describing module 402, for describing each building corresponding to the design information of the building groups as a geometry;

determining module 403, for determining the shortest distance between two adjacent the geometries according to the geometry corresponding to the each of buildings;

judging module 404, for judging whether the shortest distance complies with the building spacing standards and codes of the corresponding standards and codes of urban planning and building design;

prompting module 405, for prompting the non-complying with corresponding the building spacing standards and codes if the corresponding buildings do not comply with the corresponding building spacing standards and codes, so that the user can make changes to the building group design information according to the prompt.

Among them, the acquiring module 401 is specifically used to:

acquire the data of predefined city's standards and codes of urban planning and building design;

search and acquire the standards and codes of urban planning and building design of the building group according to the preset data of standards and codes of urban planning and building design of the city where the building group is located in.

The specific limitations of the device for masterplan's compliance checking based on standards and codes of urban planning and building design can be referred to the above for the limitations of the method for masterplan's compliance checking based on standards and codes of urban planning and building design, and will not be repeated here. The modules in the above-mentioned masterplan's compliance checking device based on standards and codes of urban planning and building design, can be performed in whole or in part through software, hardware and their combinations. All the modules described mentioned above can be embedded in or independent of the processor in the computer device in the form of hardware, or can be stored in the memory of the device masterplan's compliance checking based on standards and codes of urban planning and building design in the form of software, so as to be called by the processor to perform the operations corresponding to such modules.

In one embodiment, providing the device for masterplan's compliance checking based on standards and codes of urban planning and building design, this device for masterplan's compliance checking based on standards and codes of urban planning and building design can be a client, its internal structure is as shown in FIG. 5. This device for masterplan's compliance checking based on standards and codes of urban planning and building design, comprising: processor, memory, network interface, display and input device connected through system bus. Among them, the processor of the device for masterplan's compliance checking based on standards and codes of urban planning and building design is to provide computation and control ability. The memory of the device for masterplan's compliance checking based on standards and codes of urban planning and building design comprising non-volatile storage medium, internal memory. The non-volatile storage medium stores operating system and computer program. The internal memory provides environment for the operating system and the computer program in the non-volatile storage medium. The network interface based on masterplan's compliance checking device of standards and codes of urban planning and building design, is used to communicate with external servers via network connection. The computer program is executed by the processor to implement the method for masterplan's compliance checking based on the standards and codes of urban planning and building design.

In one embodiment, provide the device masterplan's compliance checking based on standards and codes of urban planning and building design, comprising the memory, the processor and the computer programs stored in the memory and operable on the processor, the processor implements the following steps when performing the computer program:

acquiring of building group design information, Obtaining the standards and codes of urban planning and building design corresponding to the building groups according to the cities where the building groups are located, design information for the building groups comprising the cities in which the building groups are located;

describing each building corresponding to the design information of the building group as a geometry;

determining the shortest distance between two adjacent geometries based on the corresponding geometry of each building;

judging whether the shortest distance complies with the building spacing standards and codes of the corresponding standards and codes of urban planning and building design;

if each of the corresponding buildings does not comply with the corresponding the building spacing standards and codes, a prompt is given for the corresponding the building spacing standards and codes that do not comply with so that the user can make changes to the building group design information based on the prompt.

In one embodiment, the readable storage medium is provided on which a computer program is stored, the computer program being executed by a processor to implement the following steps:

acquiring of building group design information, Obtaining the standards and codes of urban planning and building design corresponding to the building groups according to the cities where the building groups are located, design information for the building groups comprising the cities in which the building groups are located;

describing each building corresponding to the design information of the building group as a geometry;

determining the shortest distance between two adjacent geometries based on the corresponding geometry of each building;

judging whether the shortest distance complies with the building spacing standards and codes of the corresponding standards and codes of urban planning and building design;

if each of the corresponding buildings does not comply with the corresponding the building spacing standards and codes, a prompt is given for the corresponding the building spacing standards and codes that do not comply with so that the user can make changes to the building group design information based on the prompts.

It can be understood by those of ordinary skill in the art that the whole or part of the process of the method in the above embodiment can be implemented by computer program instructing relevant hardware, the computer program can be stored in a non-volatile storage medium readable by computer, the execution of the computer program can comprise the processes in the embodiments of the methods described above. Where, any reference to memory, storage, database or other medium in the embodiments provided in this application may comprise both non-volatile memory and/or volatile memory. Non-volatile memory may comprise read-only memory (ROM), programmable ROM (PROM), electrically programmable ROM (EPROM), electrically erasable and programmable ROM (EEPROM) or flash memory. Volatile memory may comprise random access memory (RAM) or external cache memory. As an illustration and not a limitation, RAM is available in various forms, such as static RAM (SRAM), dynamic RAM (DRAM), synchronous DRAM (SDRAM), Dual Data Rate SDRAM (DDRSDRAM), Enhanced SDRAM (ESDRAM), Synch link DRAM (SLDRAM), Memory Bus (Rambus) Direct RAM (RDRAM), Direct Memory Bus Dynamic RAM (DRDRAM), and Memory Bus Dynamic RAM (RDRAM), etc.

Those skilled in the art can clearly understand that, for the convenience of concise describing, only examples of the functional units and modules described above are given, in actual application, such functions described above can be assigned to different functional units and modules for completion based on the need, i.e., the internal construction of the device can be divided into different functional units or modules to complete all or partial functions described above.

The embodiments described above are merely provided for describing the technical solutions of the present disclosure rather than limitation. Although the present disclosure has been described in detail in reference to the above embodiments, those of ordinary skill in the art shall understand that they can still modify the technical solutions described in the above embodiments, or conduct equivalent replacement to some technical features therein; but such modifications or replacements will not make the nature of the relevant technical solutions depart from the spirit and scope of the technical solution in the embodiments of the present disclosure, and shall be comprised in the protection scope of the present disclosure.

What is claimed is:

1. A method for masterplan's compliance checking based on standards and codes of urban planning and building design, comprising:
acquiring the design information of the building group, and acquiring the standards and codes of urban planning and building design corresponding to the building group according to the city where the building group is located, design information for the building groups comprises the cities in which the building groups are located;
describing each building corresponding to the design information of the building group as a geometry;
determining the shortest distance between two adjacent geometries based on the corresponding geometry of each the building;
judging, on the basis of the shortest distance, whether the spacing of the corresponding buildings complies with the building spacing standards and codes of urban planning and design;
if the distance between corresponding buildings does not comply to the corresponding building spacing standards and codes, the buildings that do not comply will be prompted according to the corresponding building spacing standards and codes, so that the user can make changes to the building group design information based on the prompt.

2. The method according to claim 1, based on standards and codes of urban planning and building design, wherein acquiring the urban planning and design standards and codes corresponding to the building groups according to the city in which the building groups are located, comprises:
acquiring preset data of standards and codes of urban planning and building design, which is generated with the documented records on standards and codes of urban planning and building design for each city region in the country;
searching and acquiring the standards and codes of urban planning and building design of the building group according to the preset data of standards and codes of urban planning and building design of the city where the building group is located in.

3. The method according to claim 2, based on standards and codes of urban planning and building design, wherein the method of generating the preset data of standards and codes of urban planning and building design, comprises:
acquiring documents related to standards and codes of urban planning and building design in various urban areas of the country, and summarizing them into a document pool;
screening each of the documents in the document pool to extract text and diagrams describing specific standards and codes of urban planning and building design to acquire the preset data of standards and codes.

4. The method of masterplan's compliance checking according to claim 3, based on standards and codes of urban planning and building design, wherein prompting the non-compliance of the corresponding building spacing standards and codes, comprises:
marking of the corresponding buildings that do not meet the corresponding building spacing standards and codes;
prompting the user for not compliance with the corresponding building spacing standards and codes.

5. The method of masterplan's compliance checking according to claim 4, based on standards and codes of urban planning and building design, wherein the corresponding building spacing standards and codes comprise: gable wall spacing standards and codes, fire protection spacing standards and codes, and obstructive buildings standards and codes.

6. The method of masterplan's compliance checking according to any one in claim 1, based on standards and codes of urban planning and building design, wherein the design information of building group further comprises the construction area corresponding to each of the buildings, after acquiring the standards and codes of urban planning and building design corresponding to the building groups according to the city in which the building groups are located, comprises:
judging whether the construction area of each of the buildings complies with the construction area standards and codes of the corresponding urban planning and design standards and codes;
if the construction area of each of the buildings does not comply to the corresponding construction area standards and codes, a notification is made to the corresponding construction area standards and codes that do not comply with so that the user can make changes to the building group design information in accordance with the notification.

7. A device for masterplan's compliance checking based on urban planning standards and codes, comprises:
an acquiring module, for acquiring design information for building groups, acquiring the standards and codes of urban planning and building design corresponding to the building groups according to the cities in which the building groups are located, the building group design information comprising the cities in which the building groups are located;
a descripting module, for describing each building corresponding to the design information of building group as a geometry;
a determining module, for determining the shortest distance between the two adjacent geometries according to the geometry corresponding to each building;
a judging module, for judging on the basis of the shortest distance, whether the distance between corresponding buildings complies with the building spacing standards and codes of the corresponding standards and codes of urban planning and building design;
a prompting module, for prompting the non-complying with the corresponding building spacing standards and codes if the distance of the corresponding buildings does not comply with the corresponding building spacing standards and codes, so that the user can make changes to the building group design information according to the prompt.

8. The device for masterplan's compliance checking according to claim 7, based on standards and codes of urban planning and building design; wherein the acquiring module is specifically used for
acquiring the data of preset city's standards and codes of urban planning and building design;
searching and acquiring the standards and codes of urban planning and building design of the building group according to the preset data of standards and codes of urban planning and building design of the city where the building group is located in.

9. A device for masterplan's compliance checking based on urban planning standards and codes, comprising a memory, a processor, and a computer program stored in the memory and operable on the processor, wherein the processor performs the computer program to implement the steps of the method for masterplan's compliance checking based on standards and codes of urban planning and building design according to claim 1.

10. A readable storage medium, the readable storage medium storing a computer program, wherein the processor performs the computer program to implement the steps of the method for masterplan's compliance checking based on standards and codes of urban planning and building design according to claim 1.
